(19) United States
(12) Patent Application Publication
(10) Pub. No.: US 2026/0042302 A1
(43) Pub. Date: Feb. 12, 2026

(54) PRINTING APPARATUS, AND METHOD OF CONTROLLING PRINTING APPARATUS

(71) Applicant: CANON KABUSHIKI KAISHA, Tokyo (JP)

(72) Inventors: Yuta Ikeshima, Kanagawa (JP); Takahisa Akaishi, Kanagawa (JP); Masaaki Obayashi, Kanagawa (JP)

(21) Appl. No.: 19/282,189

(22) Filed: Jul. 28, 2025

(30) Foreign Application Priority Data
Aug. 6, 2024 (JP) 2024-130011

(51) Int. Cl. B41J 11/42; B41J 2/21

(52) U.S. Cl. CPC B41J 11/42; B41J 2/21

(57) ABSTRACT

A printing apparatus comprises a unit configured to convey a print medium by conveyance control including first conveyance control and second conveyance control, a unit configured to switch from the first conveyance control to the second conveyance control, a unit configured to print a first pattern and a second pattern on the print medium, a unit configured to measure the first pattern on the print medium conveyed according to the first conveyance control, and a unit configured to measure the second pattern on the print medium conveyed according to the second conveyance control. The second pattern is printed after printing the first pattern such that a distance between the first and second patterns is greater than or equal to a distance that the print medium is conveyed until the first conveyance control is switched to the second conveyance control after printing the first pattern.

### BACKGROUND

Field of the Technology The present disclosure relates to a printing technique.

### Description of the Related Art

Conventionally, as a method of calibrating a scanner using the scanner and a colorimeter, a method in which a correction pattern is printed at a position corresponding to an overlapping portion of a line scanner, the correction pattern is measured by the line scanner and the colorimeter, and the overlapping position of the line scanner is calibrated based on the respective measurement results is known.

When a print pattern is of a length that straddles both the scanner and the colorimeter in a conveyance direction of a sheet, due to a difference in sheet conveyance control at the time of reading between the scanner and the colorimeter, both readings cannot be performed in a single-direction conveyance control, resulting in a problem that a rewind operation becomes necessary.

### SUMMARY

The present disclosure provides a technique for scanning and colorimetrically measuring a pattern in a single conveyance of a print medium, without rewinding.

According to the first aspect of the present disclosure, there is provided a printing apparatus comprising: a conveyance unit configured to convey a print medium by conveyance control that includes first conveyance control and second conveyance control; a conveyance control unit configured to switch from the first conveyance control to the second conveyance control; a printing unit configured to print a first pattern and a second pattern, which include tones, on the print medium; a first measurement unit configured to measure the first pattern on the print medium conveyed according to the first conveyance control; and a second measurement unit configured to measure the second pattern on the print medium conveyed according to the second conveyance control, wherein the printing unit prints the second pattern after printing the first pattern such that a distance between the first pattern and the second pattern is greater than or equal to a conveyance distance that the print medium is conveyed until the first conveyance control is switched to the second conveyance control after printing of the first pattern.

According to the second aspect of the present disclosure, there is provided a method of controlling a printing apparatus, the printing apparatus comprising: a conveyance unit configured to convey a print medium by conveyance control that includes first conveyance control and second conveyance control; a conveyance control unit configured to switch from the first conveyance control to the second conveyance control; a printing unit configured to print a first pattern and a second pattern, which include tones, on the print medium; a first measurement unit configured to measure the first pattern on the print medium conveyed according to the first conveyance control; and a second measurement unit configured to measure the second pattern on the print medium conveyed according to the second conveyance control, wherein the printing unit prints the second pattern after printing the first pattern such that a distance between the first pattern and the second pattern is greater than or equal to a conveyance distance that the print medium is conveyed until the first conveyance control is switched to the second conveyance control after printing of the first pattern.

According to the third aspect of the present disclosure, there is provided a printing apparatus operable to print a measurement pattern for adjusting a color of a print image, the measurement pattern including a first pattern and a second pattern, the printing apparatus comprising: a printing unit configured to print the measurement pattern in which a distance between the second pattern and a unit configured to measure the second pattern at a start of a switch from conveyance control for a print medium for measuring the first pattern to conveyance control for the print medium for measuring the second pattern is greater than or equal to a conveyance distance that the print medium is conveyed in the switch.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of a configuration of a printing apparatus 100.

FIG. 2 is a diagram illustrating an example of a schematic configuration of a print head 101.

FIG. 3 is a block diagram illustrating an example of a configuration of a system.

FIG. 4 is a flowchart of image processing for printing in the printing apparatus 100.

FIG. 5 is a diagram illustrating a scanner correction pattern printed on a print medium.

FIG. 6A is a diagram illustrating a region of a scan pattern 502 from a leading position to a first tone pattern.

FIG. 6B is a diagram illustrating a region of a colorimetry pattern 503 from a leading position to a first tone pattern.

FIG. 7 is a diagram illustrating a positional relationship between a scanner unit 108 and a colorimetry unit 109, and the scan pattern 502 and the colorimetry pattern 503.

FIG. 8 is a flowchart of processing to be performed by the printing apparatus 100 in order to measure a scanner correction pattern.

FIG. 9A is a diagram illustrating conveyance control to be performed in parallel with a scanning operation of the scanner unit 108.

FIG. 9B is a diagram illustrating conveyance control to be performed in parallel with a scanning operation of the scanner unit 108.

FIG. 10A is a diagram illustrating conveyance control to be performed in parallel with a colorimetry operation of the colorimetry unit 109.

FIG. 10B is a diagram illustrating conveyance control to be performed in parallel with a colorimetry operation of the colorimetry unit 109.

FIG. 10C is a diagram illustrating conveyance control to be performed in parallel with a colorimetry operation of the colorimetry unit 109.

FIG. 10D is a diagram illustrating conveyance control to be performed in parallel with a colorimetry operation of the colorimetry unit 109.

FIG. 11 is a diagram illustrating a positional relationship between the scanner unit 108 and the colorimetry unit 109, and a scanner correction pattern 1101.

FIG. 12 is a flowchart of processing for generating a scanner correction table by the printing apparatus 100.

FIG. 13A is a diagram illustrating a center position of a scan tone pattern 601.

FIG. 13B is a diagram illustrating a center position of a colorimetry tone pattern 604.

FIG. 14A is a diagram illustrating derivation of a correction amount in step S1207.

FIG. 14B is a diagram illustrating derivation of a correction amount in step S1207.

FIG. 15 is a diagram illustrating an example of a configuration of a correction table.

FIG. 16A is a graph indicating variations in scan values for a pixel position X.

FIG. 16B is a graph indicating variations in scan values for the pixel position X.

FIG. 16C is a graph indicating variations in scan values for the pixel position X.

FIG. 16D is a graph indicating variations in scan values for the pixel position X.

FIG. 17A is a diagram illustrating a positional relationship between the scanner unit 108 and the colorimetry unit 109, and the scan pattern 502 and the colorimetry pattern 503.

FIG. 17B is a diagram illustrating a positional relationship between the scanner unit 108 and the colorimetry unit 109, and the scan pattern 502 and the colorimetry pattern 503.

FIG. 17C is a diagram illustrating a positional relationship between the scanner unit 108 and the colorimetry unit 109, and the scan pattern 502 and the colorimetry pattern 503.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

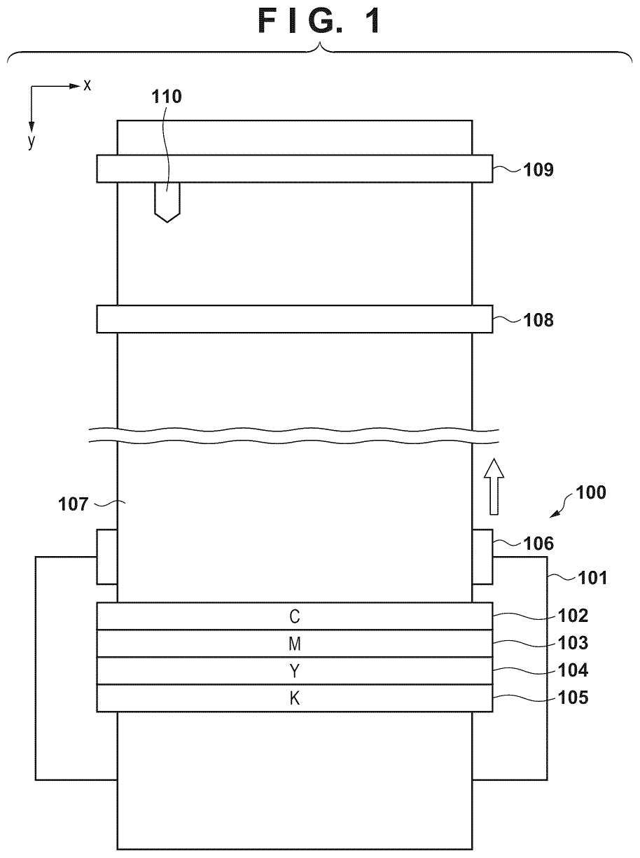

First, an example of a configuration of a printing apparatus 100 according to the present embodiment will be described with reference to FIG. 1. As illustrated in FIG. 1, the printing apparatus 100 is an inkjet printing apparatus. The printing apparatus 100 is a full-line printing apparatus and includes a print head 101, which has a width greater than or equal to a width of a print medium such as paper.

The print head 101 includes a print element array 102 in which a plurality of print elements that eject cyan (C) ink are arranged in a direction (direction along the X-axis) perpendicular to a conveyance direction of the print medium (direction along the Y-axis), a print element array 103 in which a plurality of print elements that eject magenta (M) ink are arranged in a direction along the X-axis, a print element array 104 in which a plurality of print elements that eject yellow (Y) ink are arranged in a direction along the X-axis, and a print element array 105 in which a plurality of print elements that eject black (K) ink are arranged in a direction along the X-axis. The print element arrays 102 to 105 are arranged in a direction along the Y-axis.

With such a configuration, the print head 101 can sequentially eject cyan (C), magenta (M), yellow (Y), and black (K) color inks onto the print medium.

The types of ink used in the printing apparatus 100 are not limited to C, M, Y, and K, and other types of ink may be used. The arrangement order of the print element arrays in the print head 101 is not limited to the arrangement order illustrated in FIG. 1, and may be another arrangement order.

The print medium is one sheet of print medium that allows continuous printing such as rolled paper, and is conveyed in the conveyance direction with rotation of a conveyance roller 106, and the print head 101 performs print processing for printing (forming) images and characters on the print medium by ejecting ink onto the conveyed print medium. The print medium at a position where the print processing is performed by the print head 101 is supported from below by a platen 107, which is a flat plate, to maintain smoothness and a distance from the print head 101.

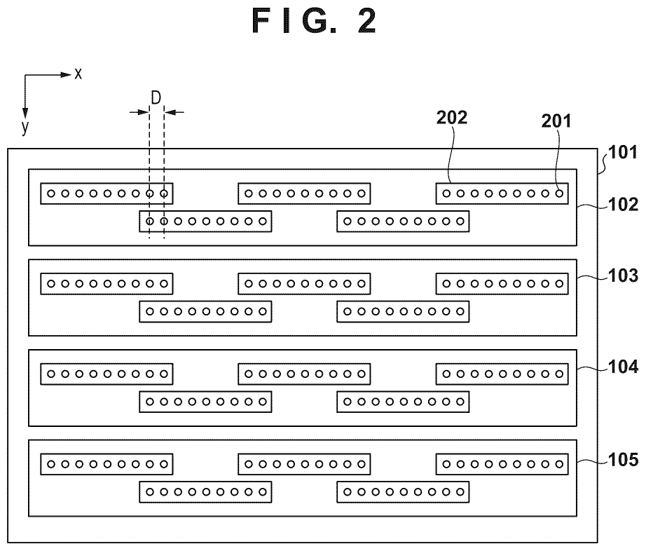

An example of a schematic configuration of the print head 101 will be described with reference to FIG. 2. In the print element arrays 102 to 105 in the print head 101, print element substrates 202 on which print elements 201 are arranged along the X-axis at a fixed pitch are arranged continuously along the X-axis with overlapping regions D and alternating in a direction along the Y-axis. The individual print elements 201 eject ink at a fixed frequency in accordance with print data onto the print medium conveyed in the conveyance direction at a fixed speed, and an image with a resolution that corresponds to the arrangement pitch of the print elements 201 is printed on the print medium.

Returning to FIG. 1, a scanner unit 108 for measuring (scanning) a scan pattern printed on the print medium by the print head 101 is provided on a conveyance path of the print medium on the downstream side of the print head 101 in the conveyance direction of the print medium.

Further, a colorimetry unit 109 for measuring (colorimetrically measuring) a colorimetry pattern printed on the print medium by the print head 101 is provided on the conveyance path of the print medium on the downstream side of the scanner unit 108 in the conveyance direction of the print medium. The colorimetry unit 109 includes a colorimeter 110, which measures the colorimetry pattern while moving along the X-axis.

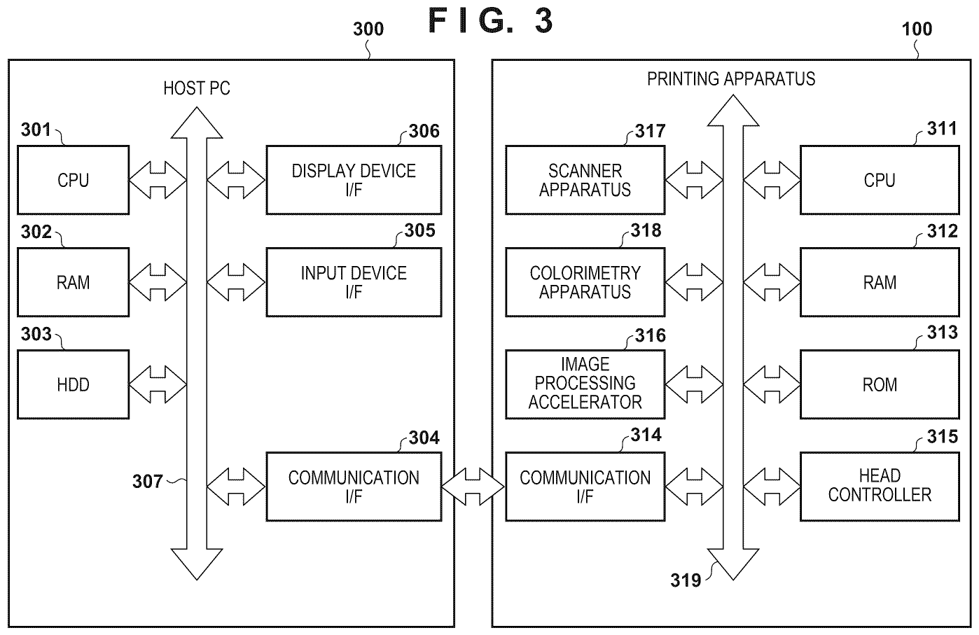

Next, an example of a configuration of a system that includes the above printing apparatus 100 will be described with reference to a block diagram of FIG. 3. As illustrated in FIG. 3, the system according to the present embodiment includes the above printing apparatus 100 and a host PC 300.

First, the host PC 300 will be described. The host PC 300 is a computer apparatus such as a PC, a tablet terminal apparatus, and a smartphone, and for example, a user can input (transmit) a print job to the printing apparatus 100 by operating the host PC 300.

A CPU 301 executes various processes using computer programs and data stored in a RAM 302. The CPU 301 thus performs control of operation of the entire host PC 300 and executes or controls various processes described as processes to be performed by the host PC 300.

The RAM 302 is an example of a volatile memory. The RAM 302 includes an area for storing computer programs and data loaded from a hard disk drive (HDD) 303 and an area for storing data received from the printing apparatus 100 via a communication I/F 304. Further, the RAM 302 includes a work area that the CPU 301 uses when executing various processes. The RAM 302 can thus provide various areas as appropriate.

The HDD 303 is an example of a non-volatile memory. The HDD 303 stores an OS, computer programs and data for causing the CPU 301 to execute or control various processes described as processes to be performed by the host PC 300, and the like.

The communication I/F 304 serves as an interface for performing data communication with the printing apparatus 100 through a network, such as a LAN or the Internet. As a method of connection for data transmission and reception in the communication I/F 304, a wired connection, such as a USB, IEEE 1394, and local area network (LAN), or a wireless connection, such as Bluetooth® and WiFi®, can be used.

An input device I/F 305 is an interface for connecting a user interface (human interface device (HID)), which is an input device such as a keyboard, a mouse, or a touch panel. The user can input various instructions and information to the host PC 300 by operating such a user interface.

A display device I/F 306 is an interface for connecting a display device that includes a liquid crystal screen or a touch panel screen. The display device displays a result of processing by the CPU 301 by using images, characters, and the like. The display device may be a projection apparatus such as a projector for projecting images and characters.

The CPU 301, the RAM 302, the HDD 303, the communication I/F 304, the input device I/F 305, and display device I/F 306 are all connected to a system bus 307. The configuration of the host PC 300 illustrated in FIG. 1 is only one example and can be modified or changed as appropriate.

Next, the printing apparatus 100 will be described. The printing apparatus 100 performs processing according to various instructions from the host PC 300, such as printing images and characters on a print medium based on a print job inputted (transmitted) from the host PC 300.

A CPU 311 executes various processes using computer programs and data stored in a RAM 312. The CPU 311 thus performs control of operation of the entire printing apparatus 100 and executes or controls various processes described as processes to be performed by the printing apparatus 100.

The RAM 312 is an example of a volatile memory. The RAM 312 includes an area for storing computer programs and data loaded from a ROM 313 and an area for storing data received from the host PC 300 via a communication I/F 314. Further, the RAM 312 includes a work area that the CPU 311 or an image processing accelerator 316 uses when executing various processes. The RAM 312 can thus provide various areas as appropriate.

The ROM 313 stores setting data of the printing apparatus 100, computer programs and data related to startup of the printing apparatus 100, and computer programs and data related to the operation of the printing apparatus 100. Further, the ROM 313 stores, for example, computer programs and data for causing the CPU 311 to execute or control various processes described as processes to be performed by the printing apparatus 100.

The communication I/F 314 serves as an interface for performing data communication with the host PC 300 through a network, such as a LAN or the Internet. As a method of connection for data transmission and reception in the communication I/F 314, a wired connection, such as a USB, IEEE 1394, and local area network (LAN), or a wireless connection, such as Bluetooth® and WiFi®, can be used.

A head controller 315 controls the operation of the above print head 101, and for example, controls a heating operation of the print head 101 based on print data. For example, when the CPU 311 writes control parameters and print data at a predetermined address in the RAM 312, the head controller 315 reads the control parameters and the print data from the predetermined address and controls the operation of the print head 101 using the read control parameters and print data to perform an operation for ejecting ink onto the print medium.

The image processing accelerator 316 is constituted by hardware and executes image processing faster than the CPU 311. For example, when the CPU 311 writes parameters and data necessary for image processing at a predetermined address in the RAM 312, the image processing accelerator 316 reads the parameters and the data from the predetermined address and performs image processing using the read parameters and data. The image processing accelerator 316 is not necessarily an essential component, and the image processing may be executed by the CPU 311 in accordance with specifications and the like of the printing apparatus 100.

A scanner apparatus 317 includes the above scanner unit 108, and optically reads the conveyed print medium using the scanner unit 108 and generates a read image (scanned image) as scanned data based on the read information.

A colorimetry apparatus 318 includes the above colorimetry unit 109 (which includes the colorimeter 110), and obtains a spectral reflectance of the conveyed print medium by using the colorimeter 110.

The CPU 311, the RAM 312, the ROM 313, the communication I/F 314, the head controller 315, the image processing accelerator 316, the scanner apparatus 317, and the colorimetry apparatus 318 are all connected to a system bus 319. The configuration of the printing apparatus 100 illustrated in FIG. 1 is only one example and can be modified or changed as appropriate.

In the present embodiment, a system in which the host PC 300 and the printing apparatus 100 are separate apparatuses will be described, but the present disclosure is not limited thereto and may be a system in which the host PC 300 and the printing apparatus 100 are integrated.

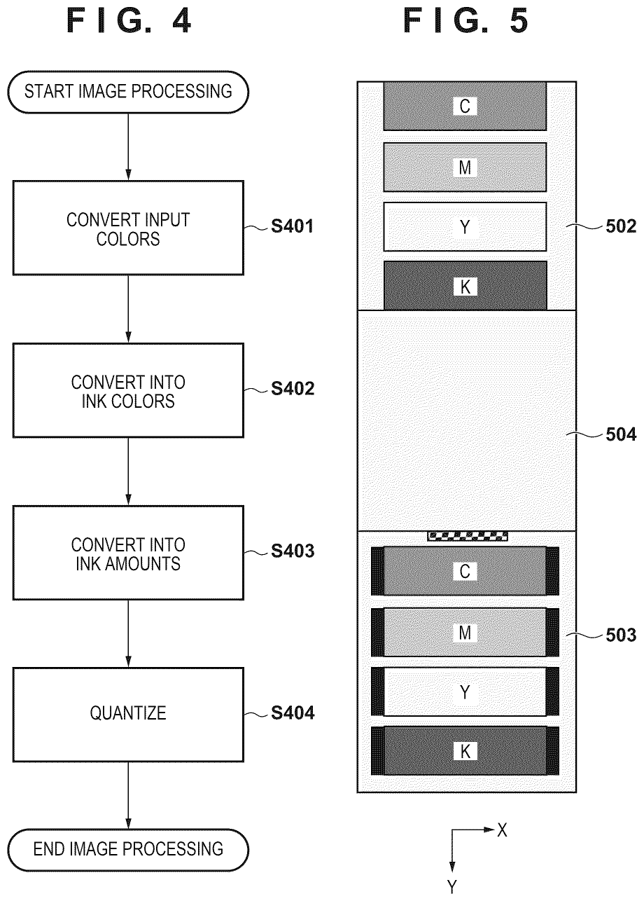

Next, image processing for printing in the printing apparatus 100 will be described in accordance with a flowchart of FIG. 4. Although a case where the processing according to the flowchart of FIG. 4 is executed by the CPU 311 will be described below, a part or all of the processing according to the flowchart of FIG. 4 may be executed by the image processing accelerator 316. Further, the processing according to the flowchart of FIG. 4 may be executed by the CPU 301 of the host PC 300.

In step S401, the CPU 311 converts an input image into an image that corresponds to a color gamut of the printing apparatus 100. In the present embodiment, the input image is data indicating color coordinates (R, G, B) in coordinates of a color space such as sRGB, which are colors represented by the monitor. The input image may be an image based on a print job or an image read out from the host PC 300 or the ROM 313.

For example, the CPU 311 converts an input image that is an 8-bit RGB image (image in which each of the red (R), green (G), and blue (B) pixel values in each pixel has an 8-bit pixel value) into an image R′G′B′ of the color gamut of the printing apparatus 100 by using a known method such as matrix operation processing or processing in which a three-dimensional lookup table (three-dimensional LUT) is used. In the present embodiment, a three-dimensional LUT is used, and an interpolation operation is used in combination therewith to convert the image. The input image is not limited to an RGB image, and for example, may be an image in which each pixel has each of the C, M, Y, and K pixel values. In that case, a four-dimensional LUT is used to convert the image instead of a three-dimensional LUT.

In step S402, the CPU 311 converts the image R′G′B′ into an image according to color signals of color inks used in the printing apparatus 100. In the present embodiment, since cyan (C), magenta (M), yellow (Y), and black (K) inks are used as color inks, the image R′G′B′ is converted into an image CMYK in which each pixel has each of the C, M, Y, and K pixel values (8 bits). This color conversion is performed using an interpolation operation in conjunction with a three-dimensional LUT, similarly to the conversion of the image in the above step S401. As another conversion method, it is also possible to use a method such as matrix operation processing, similarly to the above. Further, although four colors, C, M, Y, and K, have been given as an example of the number of inks, other inks may be added.

In step S403, the CPU 311 converts the image CMYK into ink amount signal values corrected to correspond to the number of print dots. Any method, such as a method of γ adjustment in which a one-dimensional look-up table is used, may be employed as a method of conversion to ink amount signal values.

In step S404, the CPU 311 performs quantization processing for C, M, Y, and K, which are ink amount signal values for the respective inks, obtained by the conversion in step S403. In quantization processing, there are various quantization levels, such as binarization and ternarization to 16-level quantization. Generally, at the time of binarization processing, respective ink amount signal values cyan (C), magenta (M), yellow (Y), and black (K) converted into respective C, M, Y, and K print data, each being 1-bit data indicating presence of an ink dot or absence of an ink dot. As a quantization processing method, pseudo halftone processing such as a known dither matrix method or error diffusion method may be used.

The CPU 311 stores print data obtained by such processing in the RAM 312. The head controller 315 controls ejection of ink by the print head 101 based on the print data stored in the RAM 312 and can thereby print images and characters on the conveyed print medium. The print data is stored in the RAM 312 for a fixed period of time after printing.

Next, the above scanner unit 108 and colorimetry unit 109 will be described.

The scanner unit 108 is provided as a line scanner that includes a line sensor that covers the entire width (length in a direction along the X-axis) of the print medium. The colorimetry unit 109 includes the colorimeter 110, which includes a colorimetry sensor.

The scanner unit 108 optically reads the print medium, generates a read image (scanned image) based on the read information, and stores the generated scanned image in, for example, the HDD 303.

Here, the scanned image is two-dimensional image information in which each pixel has an RGB value or a luminance value, and for example, its resolution is 600 dpi in both a direction along the X-axis and in a direction along the Y-axis. The resolution may be different between the direction along the X-axis and the direction along the Y-axis. At the time of scanning, the scanner unit 108 continuously scans the print medium while conveying the print medium and thereby obtains a scanned image that is a continuous two-dimensional image. The scanner unit 108 may include a plurality of scanners, and the respective scanners may be arranged continuously or staggered in a direction along the X-axis to cover the entire width of the print medium.

The colorimeter 110 stores a spectral reflectance obtained as described above in, for example, the HDD 303. The CPU 311 may also store color values in a device-independent color space calculated from the spectral reflectance in the HDD 303. Specifically, a spectral reflectance in 10 nm increments from 380 to 780 nm, which is the visible light range, or a result obtained by converting that spectral reflectance into data in a color space such as CIEXYZ, CIELab, sRGB, or AdobeRGB may be stored in the HDD 303. The spectral reflectance, which is a colorimetry result is obtained as a reflectance averaged within the shape of an opening of the colorimeter 110, such as a circle with a diameter φ=3.5 mm.

At the time of colorimetry, the colorimeter 110 performs measurement at each fixed distance while moving in a direction along the X-axis and can thereby perform measurement at a plurality of locations on one line. The conveyance of the print medium and one line of measurement associated with the movement of the colorimeter 110 in a direction along the X-axis are alternatingly repeated to measure the entire region of the print medium.

As will be described later, the conveyance control for the print medium at the time of scanning by the scanner unit 108 and the conveyance control for the print medium at the time of colorimetry by the colorimeter 110 are not the same, and different conveyance control is necessary at the time of scanning by the scanner unit 108 and at the time of colorimetry by the colorimeter 110. In order to perform scanning and colorimetry in a single conveyance, without rewinding, the printing apparatus 100 switches the conveyance control for the print medium to the conveyance control for scanning before the scan pattern reaches the scanner unit 108, and switches the conveyance control for the print medium to the conveyance control for colorimetry before the colorimetry pattern reaches the colorimetry unit 109 (colorimeter 110). With this, the printing apparatus 100 can perform scanning and colorimetry continuously.

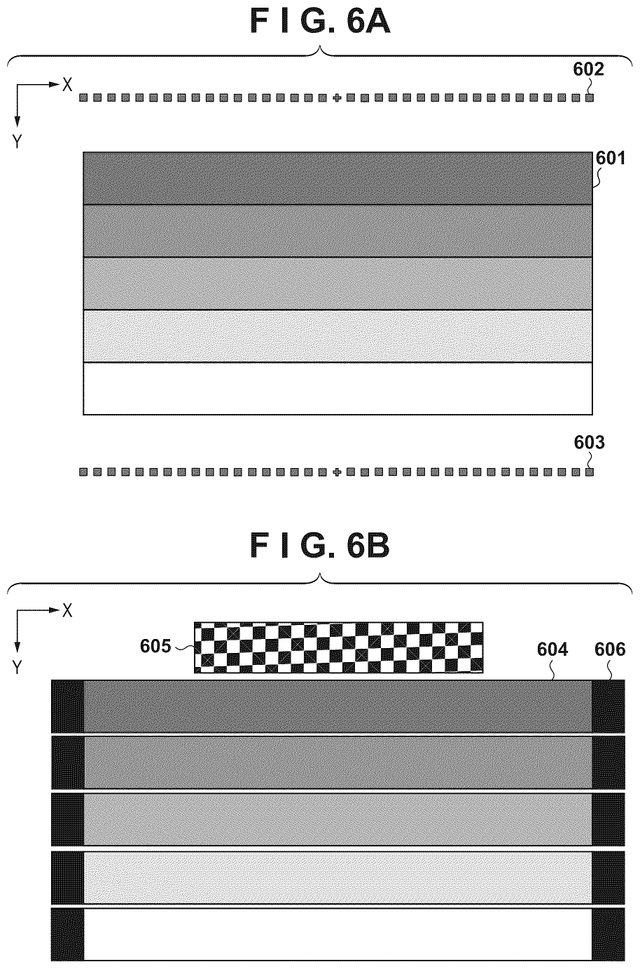

Next, a scanner correction pattern to be printed on the print medium will be described with reference to FIG. 5. As illustrated in FIG. 5, the scanner correction pattern is a pattern that is used to calibrate the scanner unit 108, and includes two patterns, the scan pattern 502 and the colorimetry pattern 503. The scan pattern 502 is printed on the conveyed print medium first, and then, the colorimetry pattern 503 is printed after an interval, which will be described later. As a result, a margin region 504 is formed between the scan pattern 502 and the colorimetry pattern 503 in the print medium.

The scan pattern 502 and the colorimetry pattern 503 both include respective corresponding tone patterns in cyan (C), magenta (M), yellow (Y), and black (K), which are ink colors.

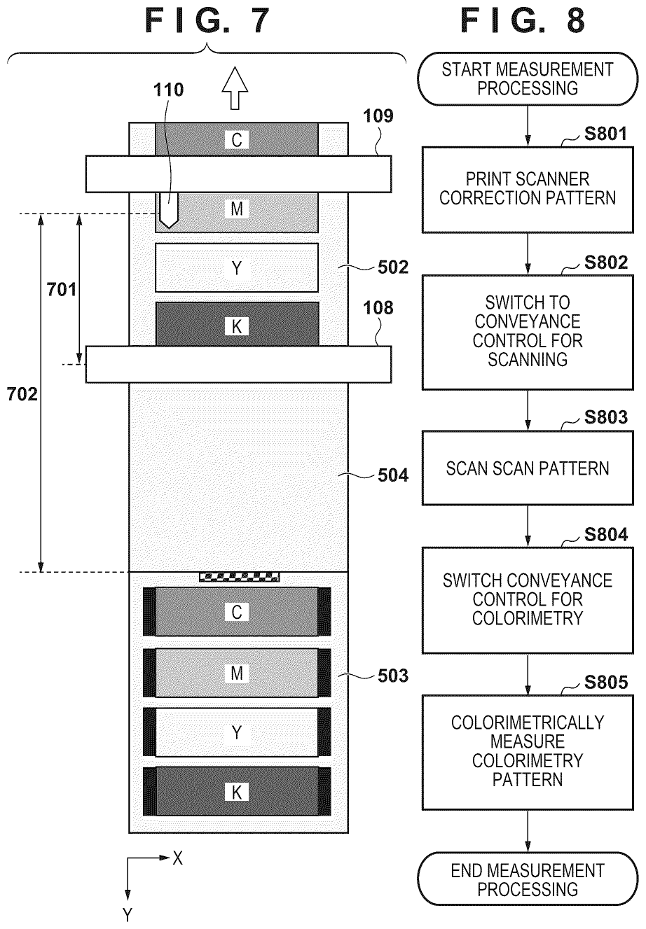

FIG. 6A is a diagram illustrating a region of the scan pattern 502 from a leading position (position at an end portion on the downstream side in the conveyance direction) to a first tone pattern. FIG. 6B is a diagram illustrating a region of the colorimetry pattern 503 from a leading position (position at an end portion on the downstream side in the conveyance direction) to a first tone pattern.

The scan pattern 502 and the colorimetry pattern 503 both have a configuration in which a plurality of patterns, each having a uniform tone value in a direction along the X-axis, are arranged by tone in a direction along the Y-axis. Although a tone pattern 601 in the scan pattern 502 and a tone pattern 604 in the colorimetry pattern 503 need not necessarily be the same, it is desirable that a range of values of tones in one tone pattern includes a range of tones that overlaps with a range of values of tones in the other tone pattern. In the following description, the tone patterns will be described as being the same for each ink color, but there is no problem even if the tone patterns are different for each ink color.

The scan pattern 502 and the colorimetry pattern 503 can include, in addition to the tone patterns, specific patterns necessary for when measuring each or when analyzing data obtained by measurement. As an example, as illustrated in FIG. 6A, the scan pattern 502 includes position identification patterns 602 and 603 for identifying the position of the tone pattern of each color and the position of each ejection nozzle. The position identification patterns 602 and 603 have a plurality of rectangles arranged at predetermined intervals in a direction along the X-axis, and the rectangle at the center position is replaced with a cross mark in order to determine a central portion of the image.

Further, the colorimetry pattern 503 may include a positioning pattern 605 for determining a colorimetry start position, and a trigger pattern 606 indicating an end of the tone pattern in a direction along the X-axis.

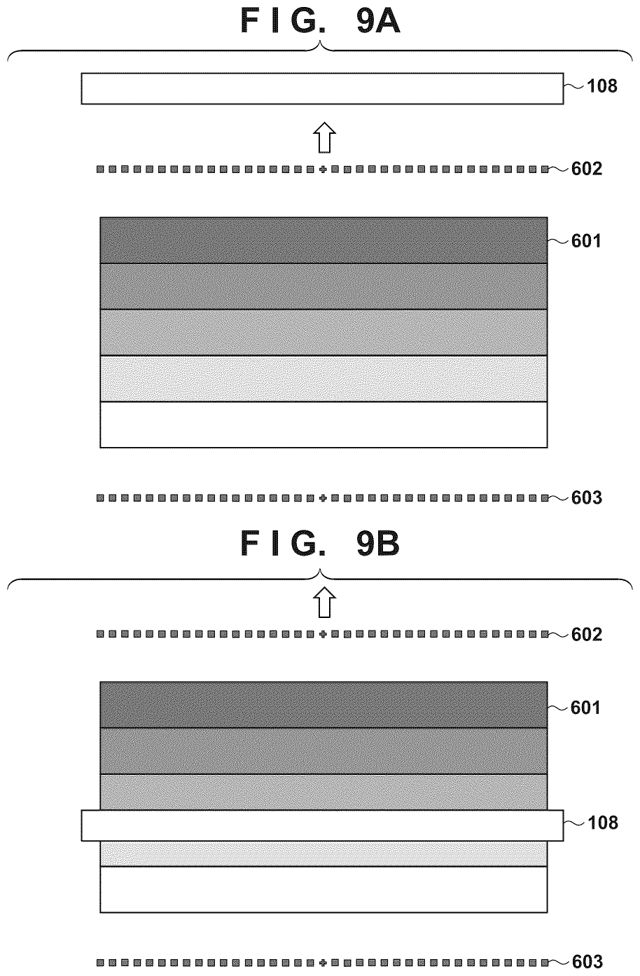

Next, the margin region 504 in FIG. 5 will be described. FIG. 7 illustrates a positional relationship between the scanner unit 108 and the colorimetry unit 109, and the scan pattern 502 and the colorimetry pattern 503, at a point in time when the scanning of the scan pattern 502 by the scanner unit 108 is completed when measuring the scanner correction pattern in the order of scanning and colorimetry. That is, in the state of FIG. 7, the scanner unit 108 has finished scanning the trailing end of the scan pattern 502 (end of the scan pattern 502 on the upstream side in the conveyance direction).

Here, since the conveyance control for scanning and the conveyance control for colorimetry differ, when continuing on to colorimetry of the colorimetry pattern 503 after completing scanning of the scan pattern 502, an operation for switching from the conveyance control for scanning to the conveyance control for colorimetry is necessary. In the switching of conveyance control, there is temporary variation in the tension in the surface of the print medium due to the switching of conveyance speed, and the conveyance height and speed of the print medium become unstable. Since the results of scanning and colorimetry will have inaccurate values when the conveyance height or speed of the print medium vary, it is desirable to perform measurement after a fixed period of time has elapsed from the start of switching of the conveyance speed, in a state in which the conveyance height and speed are stable. In the following description, it is assumed that a distance necessary for stabilization is included in a conveyance distance required to switch conveyance control (distance that the print medium is conveyed during conveyance control switching).

When continuing on to colorimetry of the colorimetry pattern 503 after completion of scanning of the scan pattern 502, a distance 702 obtained by adding a distance 701 between the colorimetry unit 109 (colorimeter 110) and the scanner unit 108 and a length of the margin region 504 in the conveyance direction (Y-axis direction) needs to be greater than or equal to a conveyance distance required to switch conveyance control.

That is, the printing apparatus 100 need only print the colorimetry pattern 503 on the print medium such that the distance 702 obtained by adding the distance 701 between the colorimetry unit 109 (colorimeter 110) and the scanner unit 108 and the length of the margin region 504 in the conveyance direction (Y-axis direction) is greater than or equal to the conveyance distance required to switch conveyance control. For example, the length of the margin region 504 in the Y-axis direction needs to satisfy the following Equation (1).

(length of margin region 504 in Y-axis direction)=(conveyance distance required to switch conveyance control)−(distance 701 between colorimetry unit 109 (colorimeter 110) and scanner unit 108) . . . (1)

Accordingly, the printing apparatus 100 prints the colorimetry pattern 503 after printing the scan pattern 502, with the margin region 504 provided such that the length of the margin region 504 in the Y-axis direction satisfies Equation (1) (or the left side is greater than the right side in Equation (1)).

Here, when the length of the margin region 504 in the Y-axis direction becomes a negative value according to Equation (1), the length of the margin region 504 in the Y-axis direction need only be set to 0, in which case the scan pattern 502 and the colorimetry pattern 503 need only be connected without a gap, or a length greater than or equal thereto need only be provided in between.

That is, the printing apparatus 100 prints the colorimetry pattern 503 after printing the scan pattern 502 such that a distance between the colorimetry unit 109 (colorimeter 110) and the colorimetry pattern 503 at the start of switching from the conveyance control for scanning to the conveyance control for colorimetry is greater than or equal to the conveyance distance that the print medium is conveyed while switching from the conveyance control for scanning to the conveyance control for colorimetry.

The conveyance distance required to switch conveyance control varies depending on the conveyance speed and the amount of variation in the conveyance height and speed of the print medium at the time of switching, but in general, the greater the conveyance speed and the greater the amount of variation in the conveyance height and speed of the print medium, the greater the required distance. Regarding the conveyance distance required for switching, a value set for each sheet setting or a conveyance setting may be obtained, or the conveyance distance required for switching may be obtained in advance as a length that allows switching regardless of the setting. For example, when the conveyance distance required to switch conveyance control is 1400 mm and the distance between the scanner unit 108 and the colorimeter 110 is 400 mm, the necessary length of the margin region 504 in the Y-axis direction becomes 1400 mm−400 mm=1000 mm (or 1000 mm or more).

The print order of the scan pattern 502 and the colorimetry pattern 503 is not limited to the above print order, and for example, may be a reverse print order to the above print order. This will be described in the following embodiments.

In addition, the scan pattern 502 and the colorimetry pattern 503 may be shared, in which case, a specific pattern necessary in each of the scanner unit 108 and the colorimeter 110 at the time of measurement will be provided in both the scan pattern and the colorimetry pattern.

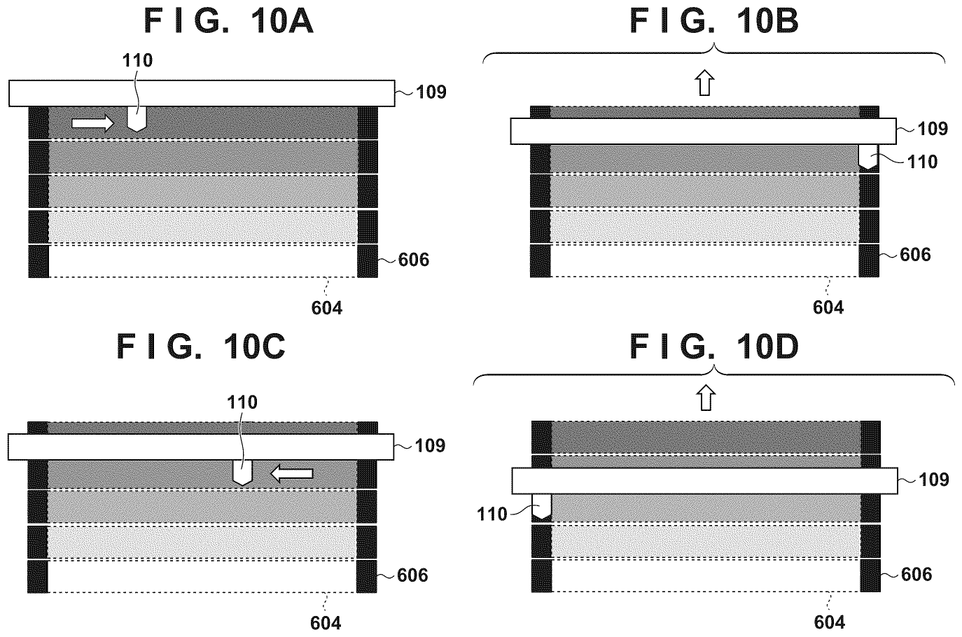

Next, processing to be performed by the printing apparatus 100 in order to measure the scanner correction pattern will be described according to a flowchart of FIG. 8.

In step S801, the head controller 315 controls the print head 101 to print a scanner correction pattern on the print medium. In printing of the scanner correction pattern, as described above, the printing apparatus 100 prints the colorimetry pattern 503 after printing the scan pattern 502, with the margin region 504 provided such that the length of the margin region 504 in the Y-axis direction satisfies Equation (1) (or the left side is greater than the right side in Equation (1)).

The scanner correction pattern is converted into quantized data by image processing, then transferred to the head controller 315, and processing for printing on the print medium is performed. The conveyance speed of the print medium at the time of print processing is determined based on the value set according to a user setting or a setting stored in advance for each print medium. After the print medium is accelerated from the stop state to the set conveyance speed and the speed has stabilized, the processing for printing on the print medium is performed by ink being ejected from the print elements 201.

In step S802, the CPU 311 switches conveyance control to go from the conveyance speed at the time of printing the scanner correction pattern to the conveyance speed at the time of starting scanning of the scan pattern 502 by the scanner unit 108. For example, when the conveyance speed at the time of printing the scanner correction pattern is greater than the conveyance speed at the time of scanning, the CPU 311 performs control to decrease the conveyance speed after the printing of the scanner correction pattern is completed, and the conveyance speed thereby becomes suitable for scanning.

In step S803, the scanner unit 108 scans the scan pattern 502 under the control of the CPU 311. Regarding the scan start position, the start position may be determined by providing a start position determination pattern at the beginning of the scan pattern 502 and performing pattern identification by a sensor of the scanner unit 108, or the start position may be determined by obtaining the rotation speed of the motor used for conveying the print medium by an encoder and estimating the conveyance distance of the print medium.

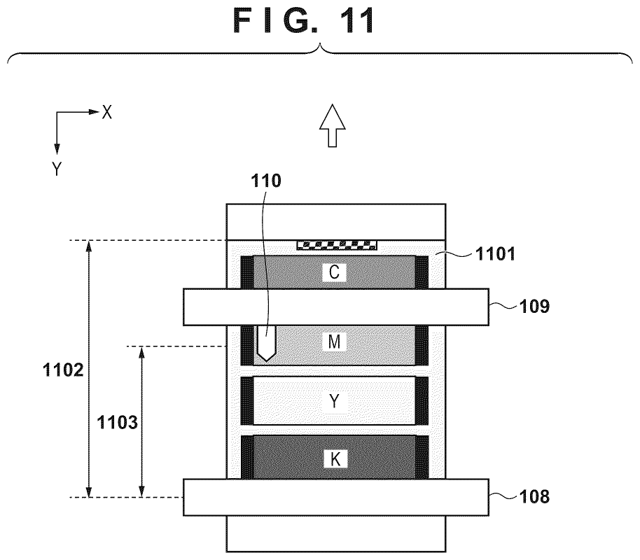

The conveyance control to be performed in parallel with the scanning operation of the scanner unit 108 will be described with reference to FIGS. 9A and 9B. In the scan processing, while the print medium is being conveyed continuously at a fixed speed, the scanner unit 108 performs scanning continuously in parallel, and a two-dimensional image in which the conveyance distance during scanning is the image height is thereby obtained.

FIG. 9A illustrates conveyance control for the print medium at the start of scanning of the scan pattern 502. Since the scanner unit 108 is a line scanner that covers the entire width of the print medium, during scanning, the scan pattern 502 can be scanned by conveying the print medium without moving the scanner unit 108 itself.

FIG. 9B illustrates conveyance control for the print medium during scanning of the scan pattern 502, and the entire region of the scan pattern 502 is scanned by performing the scanning operation by the scanner unit 108 while continuing on to convey the print medium at a fixed speed. After the scanning of the scan pattern 502 in all the colors to be scanned is completed, the scanning operation is terminated. The image height varies depending on the pixel value obtainment period of the scanner unit 108 in addition to the conveyance distance during scanning, and the aspect ratio of the obtained image does not necessarily need to match the actual aspect ratio of the printed pattern.

In step S804, the CPU 311 switches conveyance control to go from the conveyance speed at the time of scanning by the scanner unit 108 to the conveyance speed at the time of starting colorimetry of the colorimetry pattern 503 by the colorimetry unit 109. In the present embodiment, the conveyance control is switched before the leading position of the colorimetry pattern 503 reaches the colorimeter 110, and a switch to the conveyance control for colorimetry and the colorimetry operation are thus performed without rewind conveyance of the print medium. In the colorimetry operation, since the leading position of the colorimetry pattern 503 is first determined before the start of colorimetry, in the course of switching to the conveyance control for colorimetry the print medium is conveyed until a position for determining the colorimetry start position is reached.

In step S805, the colorimetry unit 109 performs colorimetry of the colorimetry pattern 503 under the control of the CPU 311. In the present embodiment, the colorimetry unit 109 determines the colorimetry start position before the start of colorimetry. In the determination of the colorimetry start position, first, based on the rotation speed of the conveyance motor, the print medium is conveyed until a position near the colorimetry pattern 503 is reached, then the conveyance control for colorimetry is switched to, and the start position determination is started. In the present embodiment, the positioning pattern 605 is used to determine the colorimetry start position, and a location where the luminance value varies is searched for while repeating conveyance control of a predetermined distance and colorimetry in the X-axis direction, and when the luminance variation estimated to be the positioning pattern is obtained, the colorimetry operation is transitioned to. In the colorimetry operation, based on a pre-stored relative distance with respect to the positioning pattern 605, the print medium is conveyed until the first tone of the tone pattern is reached, then the colorimetry operation is started. Regarding tone patterns in the second and later colors, the determination of the start position according to the positioning pattern 605 need not be performed each time, and the conveyance amount of the print medium is determined based on relative position information of the tone pattern for each ink color, and the print medium is conveyed until the beginning of the tone is reached.

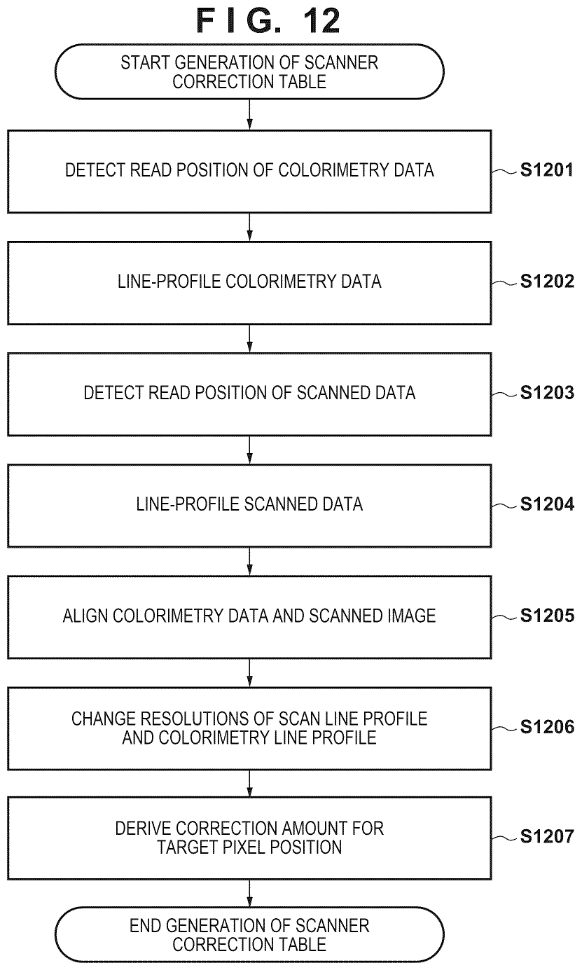

FIGS. 10A to 10D illustrate conveyance control to be performed in parallel with the colorimetry operation of the colorimetry unit 109. FIG. 10A illustrates the operation of the colorimetry unit 109 when performing colorimetry, and the colorimetry unit 109 executes colorimetry at each fixed distance while moving the colorimeter 110 in the X-axis direction (horizontal direction on the paper surface) while the conveyance of the print medium is stopped. Then, the colorimetry unit 109 stops the colorimeter 110 when the trigger pattern 606 at the end is reached after completing colorimetry of the entire area of the tone pattern for one line. The colorimeter 110 can determine the trigger mark based on the measured colorimetry value, such as by considering the variation in luminance values, for example.

Next, as illustrated in FIG. 10B, the printing apparatus 100 conveys the print medium to the next tone line. The conveyance length at this time may be determined by, for example, estimating the conveyance distance for one tone line based on the rotation speed of the motor. After conveyance of one tone line is completed, as illustrated in FIG. 10C the colorimetry unit 109 performs colorimetry while moving the colorimeter 110 along the X-axis direction in a direction opposite to that in FIG. 10A. After the colorimetry of the entire region of the tone pattern for one line is completed, as illustrated in FIG. 10D the printing apparatus 100 conveys the print medium again to the next tone line. In the colorimetry of the colorimetry pattern by the colorimeter 110, the colorimetry of the entire region of the colorimetry pattern is performed by repeatedly performing the operations of FIGS. 10A to 10D.

In the present embodiment, although the trigger pattern is arranged at the left and right ends in the X-axis direction of each tone, the trigger pattern may be arranged for each tone only on either the left or the right, and only the terminal side with respect to the movement of the colorimeter 110 may be determined. After the colorimetry of the colorimetry pattern 503 in all target colors is completed, the colorimetry operation is terminated.

After the colorimetry of the colorimetry pattern 503 is completed, the scanner correction pattern is conveyed to the downstream side in the conveyance direction of the print medium, and the operation for measuring the scanner correction pattern by the printing apparatus 100 is completed.

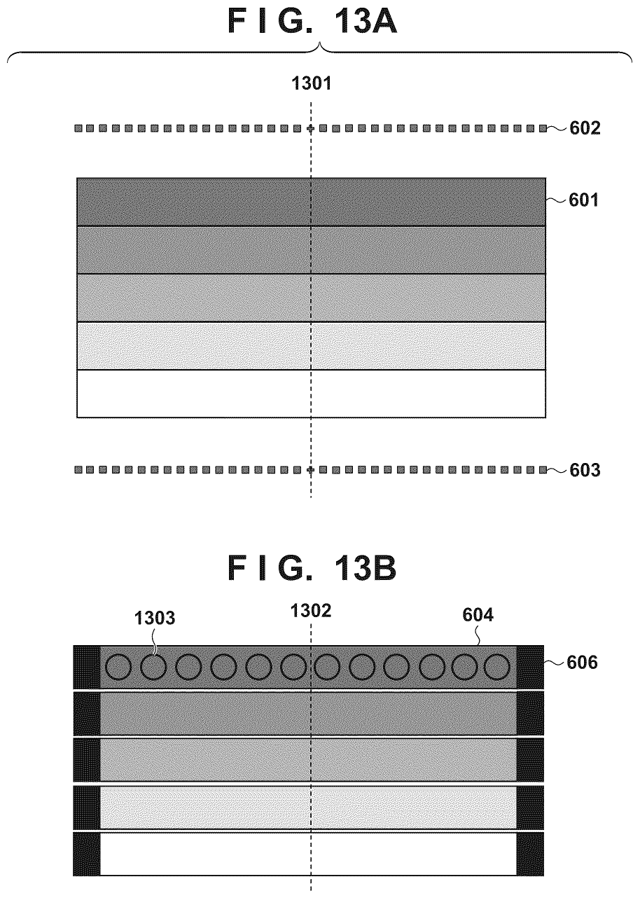

FIG. 11 illustrates a positional relationship between the scanner unit 108 and the colorimetry unit 109, and the scanner correction pattern 1101 when scanning of a scanner correction pattern in a conventional form by the scanner unit 108 is completed. That is, in the state of FIG. 11, the scanner unit 108 has finished scanning the trailing end of the scanner correction pattern 1101. The scanner correction pattern 1101 in the conventional form is one common pattern that is read by both the scanner unit 108 and the colorimetry unit 109.

When a length 1102 of the scanner correction pattern 1101 in the Y-axis direction is greater than a length 1103 from the scanner unit 108 to the colorimetry unit 109, a part of the scanner correction pattern 1101 will have passed a position of the colorimeter 110 in the colorimetry unit 109 by the time the scanning of the scanner correction pattern 1101 by the scanner unit 108 is completed. Since the scanner unit 108 and the colorimetry unit 109 differ in conveyance control at the time of measurement, measurement cannot be performed at the same time, and when performing colorimetry by the colorimetry unit 109 after scanning by the scanner unit 108 of the scanner correction pattern 1101 is completed, a rewind operation of the print medium is necessary. The rewind operation of the print medium may increase the time required for conveying the print medium, and the conveyance control may become unstable due to rewinding, resulting in a decrease in accuracy.

Meanwhile, according to the present embodiment, since a measurement pattern is prepared for each of the scanner unit 108 and the colorimetry unit 109, and a sufficient length is provided between the colorimeter 110 in the colorimetry unit 109 and the colorimetry pattern 503 in order to switch conveyance control to the conveyance speed for starting colorimetry by the colorimetry unit 109 after scanning by the scanner unit 108 is completed, colorimetry by the colorimetry unit 109 can be transitioned to without rewinding the print medium.

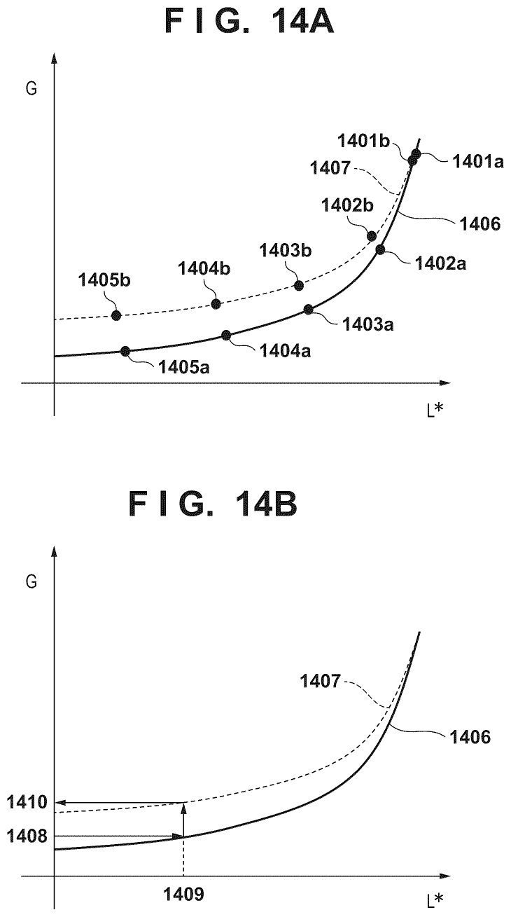

Next, generation of a scanner correction table will be described. The printing apparatus 100 generates a scanner correction table based on scanned data obtained by scanning in step S803 and colorimetry data, which is spectral reflectance data obtained by colorimetry in step S805. The processing for generating the scanner correction table by the printing apparatus 100 will be described according to a flowchart of FIG. 12.

In step S1201, the CPU 311 detects a read position of colorimetry data. In the detection of the read position of the colorimetry data, first, the position of each colorimetry value in the X-axis direction is obtained with reference to the end position obtained by the trigger mark of the colorimetry pattern 503. Colorimetry is performed at each fixed distance in the X-axis direction, the position of each measurement location in the X-axis direction can be identified from the number of measurements in the X-axis direction in the line of each tone in the tone pattern 604 with reference to the trigger pattern 606. Further, with this, the center position in the line of each tone in the X-axis direction can be identified.

In step S1202, the CPU 311 line-profiles colorimetry data. Specifically, the CPU 311 obtains line profiles corresponding to the number of colorimetry points in the X-axis direction for one tone line, and sets it as a colorimetry line profile in a respective tone (hereinafter, simply referred to as a colorimetry line profile). According to the present embodiment, this makes it possible to obtain colorimetry line profiles of five tones for each colorimetry point in the X-axis direction.

In step S1203, the CPU 311 detects a read position of scanned data. In the detection of the read position of the scanned data, first, the tone pattern 601 for each ink color in the scan pattern 502 is identified from the scanned image.

The position identification patterns 602 and 603 are used to identify the position of the tone pattern 601 for each color. In the detection of the position identification pattern, a method of identifying and detecting rectangles and a cross by performing comparison with a surface area threshold, vertex detection for each color, or the like on the scanned image is considered. By detecting the upper and lower position identification patterns, the region therebetween is identified as the tone pattern 601 in the target color based on relative position information. Further, if the cross pattern is assumed as the center position of the position identification pattern, it will be possible to estimate a position in the X-axis direction from the relative position of each rectangle in the position identification pattern. When the detection positions of the upper and lower position identification patterns are compared and it is determined that the colorimetry tone pattern is tilted, processing for keeping the colorimetry tone pattern level may be performed, such as rotation processing for the scan line profile or obtainment of scan values in consideration of the tilt when calculating average one-dimensional data.

In step S1204, the CPU 311 line-profiles scanned data. Specifically, one-dimensional scan average data obtained by averaging sensor values in the conveyance direction (Y-axis direction) for each tone in the tone pattern. The one-dimensional scan average data is obtained by averaging read values of each tone for each scan pixel column in the X-axis direction, and this is used as the scan line profile. According to the present embodiment, this makes it possible to obtain line scan profiles of five tones for each scan pixel column in the X-axis direction.

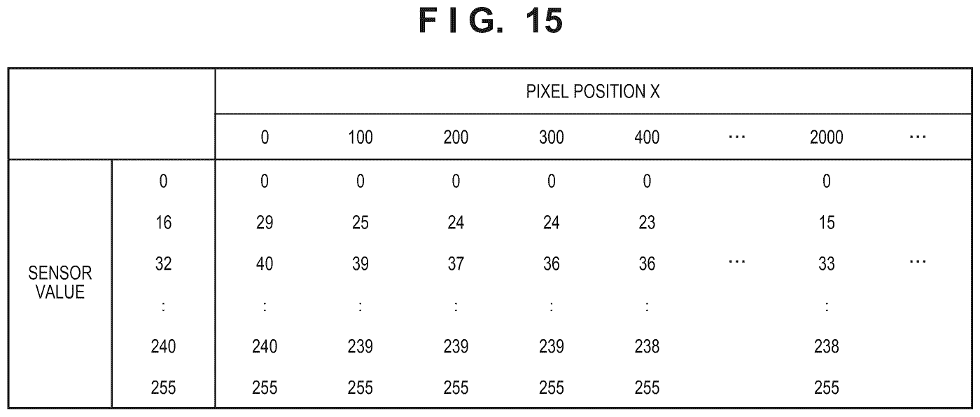

In step S1205, the CPU 311 aligns the scan line profile and the colorimetry line profile. FIGS. 13A and 13B are diagrams illustrating the center position of the scan tone pattern 601 and the colorimetry tone pattern 604, respectively. As illustrated in FIG. 13A, in the scan tone pattern 601, the position of the detected cross mark can be determined as the center position, and the scan pixel column having the same position in the scan line profile is a center position 1301. As illustrated in FIG. 13B, in the colorimetry line profile, a position 1302 corresponding to the center position can be estimated from the number of colorimetry locations 1303 in the X-axis direction with respect to the trigger pattern 606, and the relative position from the center position for each colorimetry value in the colorimetry line profile can be determined. In the alignment of the scan line profile and the colorimetry line profile, the alignment is possible by associating the respective center positions.

In step S1206, the CPU 311 converts the resolution for each of the scan line profile and the colorimetry line profile. Specifically, the CPU 311 converts the resolutions by averaging such that the scan line profiles have a shared resolution in the X-axis direction. It is not necessary to use all of the scan pixel columns for the averaging in the X-axis direction, and an average may be taken using only the scan pixel columns in the vicinity with reference to an X position of the colorimetry line profile.

For the Y-axis direction, the CPU 311 performs processing for expanding the number of tones by interpolation such that the resolutions of the scan line profile and the colorimetry line profile will become the same. In the present embodiment, both the scan line profile and the colorimetry line profile have five tones of line profile, and for example, both are expanded to 256 tones in consideration of the accuracy in generating the scan correction table. As for interpolation for expanding the number of tones, interpolation methods such as simple linear interpolation, as well as multi-dimensional interpolation may be freely selected.

In step S1207, the CPU 311 derives a correction amount for the target pixel position and determines a corrected sensor value for the target pixel position. With this processing, the corrected pixel value for each column in the X-axis direction of the scan line profile, for example, output values, “0, 29, 40,. . . 240, 255”, when the pixel position X=0 is obtained.

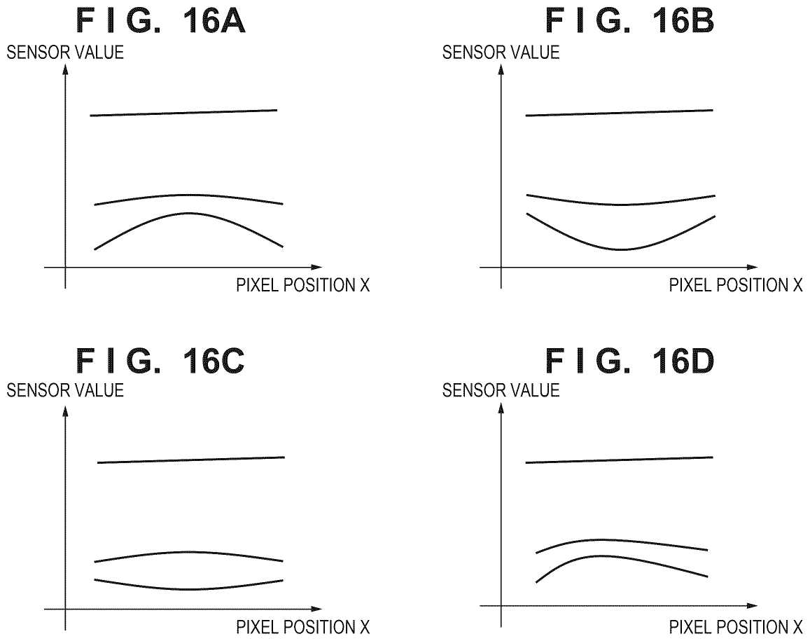

The derivation of the correction amount in step S1207 will be described with reference to FIGS. 14A and 14B. FIGS. 14A and 14B are graphs both with the colorimetry value (L*) on the horizontal axis and the sensor value (G channel value) of a G sensor among RGB sensors constituting the line sensor on the vertical axis.

The graph of FIG. 14A indicates points 1401a to 1405a obtained by plotting the colorimetry value (L*) and the G channel value at each tone position of the tone pattern. For example, the point 1401a represents the colorimetry value (L*) and the G channel value in a paper-white tone. In addition, the point 1402a represents the colorimetry value (L*) and the G channel value in the lightest gray measurement region, and the point 1405a represents the colorimetry value (L*) and the G channel value in the darkest gray measurement region. A curve 1406 in FIG. 14A is a curve obtained by using approximation processing or an interpolation operation such as known spline interpolation or piecewise linear interpolation on the plotted points 1401a to 1405a. A curve 1407 in FIG. 14A is the target reading characteristic, which represents the target values of the sensor values after correction. The target value is calculated from, for example, a scan value and a colorimetry value corresponding to any one position X. In FIG. 14A, points 1401b to 1405b are points obtained by plotting the colorimetry values of X positions to be the target values and corresponding sensor values. The curve 1407 may be obtained by using approximate processing and an interpolation operation on the points 1401b to 1405b, similarly to the curve 1406. The curve representing the reading characteristic of the sensor to be the reference may be held in advance as the target reading characteristic, and used. Alternatively, the sensor value may be determined in advance to be linear with respect to luminance, L*, or optical density, held, and used.

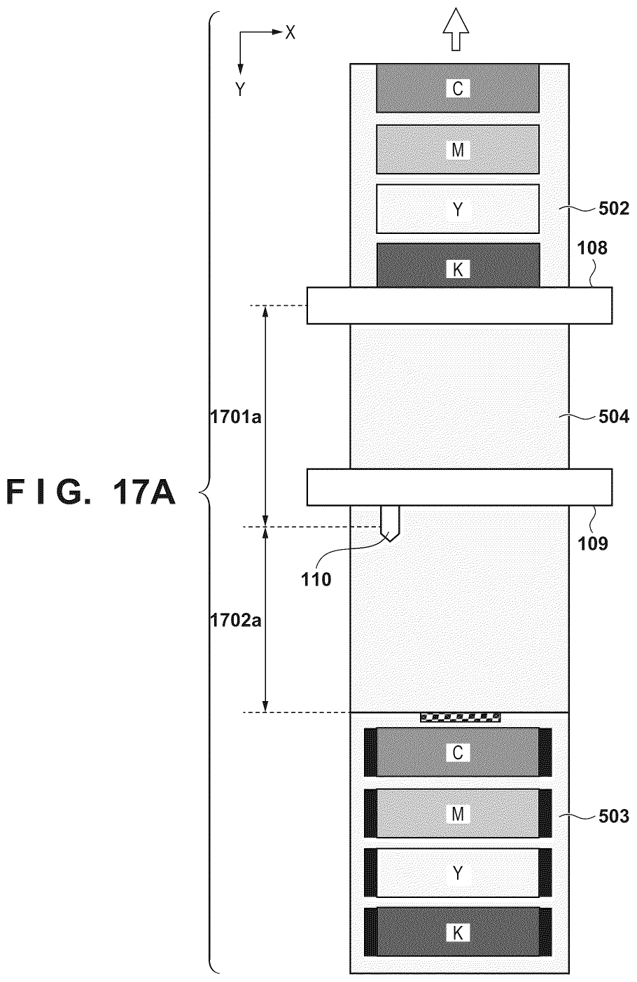

FIG. 14B is a diagram illustrating how the corrected sensor value is determined from the two curves 1406 and 1407 thus obtained. In FIG. 14B, a G channel value 1408 represents an uncorrected sensor value. First, a colorimetry value L*1409 corresponding to the G channel value 1408 is obtained from the curve 1406. Next, a target G channel value 1410 corresponding to the colorimetry value L*1409 is obtained from the target curve 1407. The target G channel value 1410 thus obtained and the uncorrected G channel value 1408 are associated with each other, and stored in the RAM 312 or the like in association with the target pixel position in the scanner correction table being generated. However, when the uncorrected sensor value is 0 or the maximum output value (e.g., 255), it may be forcibly made 0 or the maximum output value. By repeating such processing for the number of columns of the scan line profile in the X direction, a correction table for each column of the scan line profile in the X direction in each ink color as illustrated in FIG. 15 is determined.

Then, by performing such processing for each of the CMYK ink colors, a scanner correction table corresponding to each ink color is obtained. The generation of the scanner correction table may not necessarily be performed for all of the ink colors. For example, a scanner correction table may be generated only for a particular predetermined ink color.

Although in the present embodiment a method of generating the scanner correction table on the assumption that the scanner unit 108 includes one scanner has been described, when the scanner unit 108 includes a plurality of scanners, by generating the scanner correction table for each scanner, it is possible to correct the scan pixel values for the entire width of the print medium.

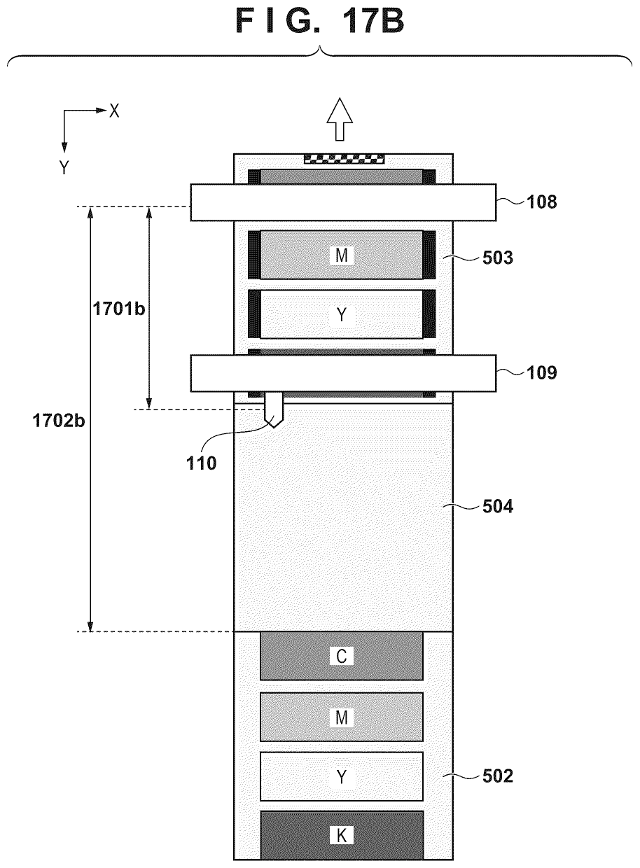

The reading characteristic of the scanner often depends on the angle of incidence with respect to a sensor pixel or color filter in the scanner, and the read value gradually increases or decreases depending on the position of the sensor pixel. FIGS. 16A to 16D are graphs with the pixel position X on the horizontal axis and the sensor value (scan value) on the vertical axis, and indicate the variation in the scan values with respect to the pixel position X. Each curve on the graph indicates an example of the scan value for each pixel position X when the spectral reflectance on the print medium is obtained by reading one tone line of the tone pattern. It is assumed that the greater the reflectance (i.e., the closer to white paper) of the tone of the pattern, the greater the scan value, and the smaller the reflectance (i.e., the greater the density on the print medium) of the tone of the pattern, the smaller the scan value. As illustrated in FIGS. 16A and 16B, often, the smaller the scan values of the tone pattern that the curve corresponds to, the greater the difference between the center portion and the end portions in the X-axis direction. That is, often, the greater the color signal value and the greater the image density on the print medium, the greater the difference in the reading characteristic of the scanner. One cause may be that the angle of incidence with respect to the sensor in the scanner increases at the end portions, resulting in a longer optical path on the color filter provided in the sensor pixel. Specifically, a change in spectral distribution due to the color filter for the light incident on the sensor increases at the end portions compared to the center portion, which may result in a change in the sensor value. Meanwhile, another cause may be that when the angle of incidence with respect to the sensor is large, for example, the light that should enter the G sensor enters as stray light into the adjacent B sensor. When a plurality of these causes occur at the same time, as illustrated in FIG. 16C, approximate forms (convex upward and convex downward) of the reading characteristics of the scanner may change depending on the average scan value. Therefore, respective tone patterns of the scan pattern 502 and the colorimetry pattern 503 may include uniform measurement regions in a plurality of color signal values. Further, when the inner structure of the scanner unit 108 is not symmetrical, there may be asymmetry as in FIG. 16D.

Next, a method of correcting scanned data using the generated scanner correction table when scanned data is obtained by the scanner unit 108 will be described. In the scanner correction table of FIG. 15, corrected scan values that correspond to respective scan values (0, 16, 32, . . . 240, 255) included in the scanned data are stored in association with pixel positions (0, 100, 200, 300, 400, . . ., 1000, . . .) in the X-axis direction. For example, if the pixel value of the pixel position “100” is “32”, the corrected pixel value of the scanned data will be “39”. The pixel values that are not specified in the scanner correction table indicated in FIG. 15 are calculated by interpolation processing in which correction values for adjacent pixel positions among those specified are used. Similarly, the scan values of the pixel positions that are not present in the scanner correction table are also calculated by interpolation processing on correction values for adjacent pixel positions among those specified. Of course, correction values for all pixel positions and pixel values may be stored instead of using the interpolation processing. Regarding the scanner correction table, it is also possible to perform correction processing by function conversion or matrix conversion instead of the table method.

Next, correction processing according to the scanner correction table is performed on the scanned data based on pixel position in the X-axis direction. As an example, an example in which the scan pixel value is “24” when the pixel position X in the X-axis direction=50 will be described. In this case, first, scan correction values for the scan value “24” at the pixel positions X=0 and 100 are obtained by interpolation operation. Specifically, for the pixel position X=0, based on the correction values “29” and “40”, which correspond to the pixel values “16” and “32”, 29+(40−29)×(24−16)/(32−16)=34.5 is obtained as a correction value. Similarly, for the pixel position X=100, 32.0 is obtained as a correction value. Then, based on the two calculated correction values “34.5” and “32.0”, 32.0+(34.5−32.0)×(100−50)/(100−0)=33.25 is obtained as the correction value for the pixel position X=50. By thus obtaining for the scan values the correction values at respective pixel positions in the X-axis direction based on the scanner correction table, scanned data that has been subjected to correction processing is obtained. The application target of the scanner correction table need not be limited to the scanned data itself, and for example, may be the scan line profile generated from the scanned data.

### Second Embodiment

Differences from the first embodiment will be described below, and unless otherwise mentioned, it is assumed that the rest is the same as the first embodiment. In the first embodiment, a case where the colorimetry unit 109 is provided on the downstream side of the scanner unit 108 in the conveyance direction of the print medium, and the scan pattern 502 is printed on the downstream side of the colorimetry pattern 503 in the conveyance direction of the print medium in the scanner correction pattern has been described.

However, the arrangement order of the colorimetry unit 109 and the scanner unit 108 in the conveyance direction of the print medium and the arrangement order of the scan pattern 502 and the colorimetry pattern 503 in the conveyance direction of the print medium are not limited to the above case. In the present embodiment, another case of such arrangement order will be described.

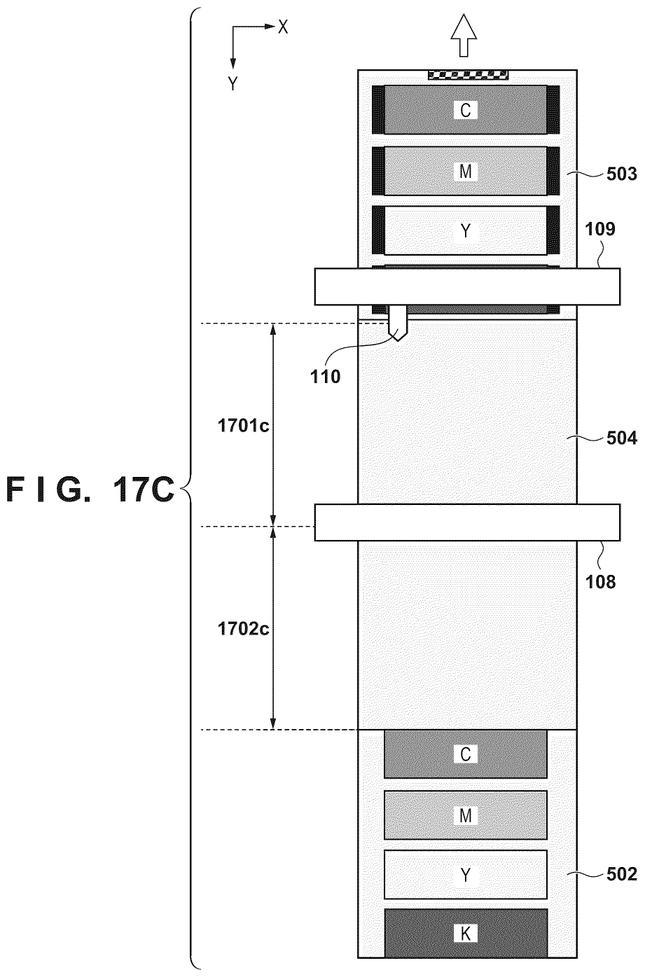

FIG. 17A illustrates a positional relationship between the scanner unit 108 and the colorimetry unit 109, and the scan pattern 502 and the colorimetry pattern 503, at a point in time when the scanning of the scan pattern 502 by the scanner unit 108 is completed when measuring the scanner correction pattern in the order of scanning and colorimetry. That is, FIG. 17A illustrates a case where the arrangement order of the scanner unit 108 and the colorimetry unit 109 is opposite to that of the first embodiment (FIG. 7). Here, for the measurement order of the scan pattern and the colorimetry pattern in the scanner correction pattern, measurement is performed in order from the pattern arranged on the downstream side in the conveyance direction of the print medium.

In the case of FIG. 17A, when continuing on to colorimetry of the colorimetry pattern 503 after scanning of the scan pattern 502 is completed, a remaining distance 1702a obtained by subtracting a distance 1701a between the colorimetry unit 109 (colorimeter 110) and the scanner unit 108 from the length of the margin region 504 in the conveyance direction (Y-axis direction) needs to be greater than or equal to the conveyance distance required to switch conveyance control.

That is, in the printing apparatus 100, the colorimetry pattern 503 need only be printed on the print medium such that the length of the margin region 504 in the conveyance direction (Y-axis direction) is greater than or equal to a distance obtained by adding the distance between the colorimetry unit 109 (colorimeter 110) and the scanner unit 108 and the conveyance distance required to switch conveyance control. For example, the length of the margin region 504 in the Y-axis direction needs to satisfy the following Equation (2).

(length of margin region 504 in Y-axis direction)=(conveyance distance required to switch conveyance control)+(distance between colorimetry unit 109 (colorimeter 110) and scanner unit 108) . . . (2)

Accordingly, the printing apparatus 100 prints the colorimetry pattern 503 after printing the scan pattern 502, with the margin region 504 provided such that the length of the margin region 504 in the Y-axis direction satisfies Equation (2) (or the left side is greater than the right side in Equation (2)).

For example, the conveyance distance required to switch conveyance control is 1400 mm and the distance between the scanner unit 108 and the colorimeter 110 is 400 mm, the necessary length of the margin region 504 in the Y-axis direction becomes 1400 mm+400 mm=1800 mm (or 1800 mm or more).

FIG. 17B illustrates a positional relationship between the scanner unit 108 and the colorimetry unit 109, and the scan pattern 502 and the colorimetry pattern 503, at a point in time when colorimetry of the colorimetry pattern 503 by the colorimetry unit 109 is completed when measuring the scanner correction pattern in the order of scanning and colorimetry. That is, FIG. 17B illustrates a case in which the arrangement order of the scan pattern 502 and the colorimetry pattern 503 is reversed in the case of FIG. 17A.

In the case of FIG. 17B, when continuing on to scanning of the scan pattern 502 after colorimetry of the colorimetry pattern 503 is completed, a distance 1702b obtained by adding a distance 1701b between the colorimetry unit 109 (colorimeter 110) and the scanner unit 108 and the length of the margin region 504 in the conveyance direction (Y-axis direction) needs to be greater than or equal to the conveyance distance required to switch conveyance control.

That is, the printing apparatus 100 may print the scan pattern 502 on the print medium such that the distance 1702b obtained by adding the distance 1701b between the colorimetry unit 109 (colorimeter 110) and the scanner unit 108 and the length of the margin region 504 in the conveyance direction (Y-axis direction) is greater than or equal to the conveyance distance required to switch conveyance control. For example, the length of the margin region 504 in the Y-axis direction needs to satisfy the above Equation (1).

Accordingly, the printing apparatus 100 prints the scan pattern 502 after printing the colorimetry pattern 503 with the margin region 504 provided such that the length of the margin region 504 in the Y-axis direction satisfies Equation (1) (or the left side is greater than the right side in Equation (1)).

FIG. 17C illustrates a positional relationship between the scanner unit 108 and the colorimetry unit 109, and the scan pattern 502 and the colorimetry pattern 503, at a point in time when colorimetry of the colorimetry pattern 503 by the colorimetry unit 109 is completed when measuring the scanner correction pattern in the order of scanning and colorimetry. FIG. 17C illustrates a case in which the arrangement order of the scanner unit 108 and the colorimetry unit 109 is reversed in the case of FIG. 17B.

In the case of FIG. 17C, when continuing on to scanning of the scan pattern 502 after colorimetry of the colorimetry pattern 503 is completed, a remaining distance 1702c obtained by subtracting a distance 1701c between the colorimetry unit 109 (colorimeter 110) and the scanner unit 108 from the length of the margin region 504 in the conveyance direction (Y-axis direction) needs to be greater than or equal to the conveyance distance required to switch conveyance control.

That is, in the printing apparatus 100, the scan pattern 502 need only be printed on the print medium such that the remaining distance 1702c obtained by subtracting the distance 1701c between the colorimetry unit 109 (colorimeter 110) and the scanner unit 108 from the length of the margin region 504 in the conveyance direction (Y-axis direction) is greater than or equal to the conveyance distance required to switch conveyance control. For example, the length of the margin region 504 in the Y-axis direction needs to satisfy the above Equation (2).

Accordingly, the printing apparatus 100 prints the scan pattern 502 after printing the colorimetry pattern 503 with the margin region 504 provided such that the length of the margin region 504 in the Y-axis direction satisfies Equation (2) (or the left side is greater than the right side in equation (2)).

As described above, the margin region is determined according to the arrangement order of the scanner unit 108 and the colorimetry unit 109 on the conveyance path, the arrangement order of the scan pattern and the colorimetry pattern in the scanner correction pattern, and thus, the scanner correction pattern can be measured in a single conveyance that does not include rewinding regardless of their arrangement order.

The numerical values, processing timing, processing order, processing performer, data (information) configuration/obtainment method/transmission destination/transmission source/storage location, and the like used in the above embodiments have been given as examples for the sake of providing a concrete explanation, and the present disclosure is not intended to be limited to such examples.

Further, some or all of the embodiments described above may be appropriately combined and used. Further, some or all of the embodiments described above may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-130011, filed Aug. 6, 2024, which is hereby incorporated by reference herein in its entirety.

What is claimed is:

1. A printing apparatus comprising:
a conveyance unit configured to convey a print medium by conveyance control that includes first conveyance control and second conveyance control;
a conveyance control unit configured to switch from the first conveyance control to the second conveyance control;
a printing unit configured to print a first pattern and a second pattern, which include tones, on the print medium;
a first measurement unit configured to measure the first pattern on the print medium conveyed according to the first conveyance control; and
a second measurement unit configured to measure the second pattern on the print medium conveyed according to the second conveyance control,
wherein the printing unit
prints the second pattern after printing the first pattern such that a distance between the first pattern and the second pattern is greater than or equal to a conveyance distance that the print medium is conveyed until the first conveyance control is switched to the second conveyance control after printing of the first pattern.

2. The printing apparatus according to claim 1, wherein
the printing unit prints the second pattern such that a distance obtained by adding a distance between the first measurement unit and the second measurement unit and a length of a margin region between the first pattern and the second pattern in a conveyance direction is greater than or equal to the conveyance distance.

3. The printing apparatus according to claim 2, wherein
the first measurement unit is arranged on an upstream side of the second measurement unit in the conveyance direction of the print medium, and
the first pattern is printed on a downstream side of the second pattern in the conveyance direction of the print medium.

4. The printing apparatus according to claim 2, wherein
the first pattern is a scan pattern, and the second pattern is a colorimetry pattern.

5. The printing apparatus according to claim 2, wherein
the first pattern is a colorimetry pattern, and the second pattern is a scan pattern.

6. The printing apparatus according to claim 1, wherein
the printing unit prints the second pattern such that a length of a margin region between the first pattern and the second pattern in the conveyance direction is greater than or equal to a distance obtained by adding a distance between the first measurement unit and the second measurement unit and the conveyance distance.

7. The printing apparatus according to claim 6, wherein
the first measurement unit is arranged on a downstream side of the second measurement unit in the conveyance direction of the print medium, and
the first pattern is printed on a downstream side of the second pattern in the conveyance direction of the print medium.

8. The printing apparatus according to claim 6, wherein
the first pattern is a scan pattern, and the second pattern is a colorimetry pattern.

9. The printing apparatus according to claim 6, wherein
the first pattern is a colorimetry pattern, and the second pattern is a scan pattern.

10. The printing apparatus according to claim 1, wherein
the print medium is rolled paper.

11. A method of controlling a printing apparatus, the printing apparatus comprising:
a conveyance unit configured to convey a print medium by conveyance control that includes first conveyance control and second conveyance control;
a conveyance control unit configured to switch from the first conveyance control to the second conveyance control;
a printing unit configured to print a first pattern and a second pattern, which include tones, on the print medium;
a first measurement unit configured to measure the first pattern on the print medium conveyed according to the first conveyance control; and
a second measurement unit configured to measure the second pattern on the print medium conveyed according to the second conveyance control,
wherein the printing unit
prints the second pattern after printing the first pattern such that a distance between the first pattern and the second pattern is greater than or equal to a conveyance distance that the print medium is conveyed until the first conveyance control is switched to the second conveyance control after printing of the first pattern.

12. A printing apparatus operable to print a measurement pattern for adjusting a color of a print image,
the measurement pattern including a first pattern and a second pattern, the printing apparatus comprising: a printing unit configured to print the measurement pattern in which a distance between the second pattern and a unit configured to measure the second pattern at a start of a switch from conveyance control for a print medium for measuring the first pattern to conveyance control for the print medium for measuring the second pattern is greater than or equal to a conveyance distance that the print medium is conveyed in the switch.
